(19) United States
(12) Patent Application Publication
(10) Pub. No.: US 2018/0077080 A1
(43) Pub. Date: Mar. 15, 2018

(54) SYSTEMS AND METHODS FOR ADAPTIVE AND INTELLIGENT NETWORK FUNCTIONS VIRTUALIZATION WORKLOAD PLACEMENT

(71) Applicant: Ciena Corporation, Hanover, MD (US)

(72) Inventors: Michaël GAZIER, Ottawa (CA); Robert TOMKINS, Ottawa (CA); Ian DUNCAN, Ottawa (CA); Daniel RIVAUD, Ottawa (CA)

(21) Appl. No.: 15/266,296

(22) Filed: Sep. 15, 2016

(51) Int. Cl. H04L 12/927; H04L 12/46; H04L 29/08

(52) U.S. Cl. CPC H04L 47/803; H04L 67/16; H04L 12/4641

(57) ABSTRACT

A method for adaptive and intelligent Network Functions Virtualization (NFV) workload placement includes monitoring operation of a network with resources including one or more Virtual Network Functions (VNFs) and microservices; responsive to a request for a service in the network, decomposing the service into interconnected functional atoms, with the functional atoms located in one or more network domains including one or more of different data centers in the network and a user device associated with the service, wherein the functional atoms are decompositions of the VNFs and the microservices into a smaller level of functionality than the VNFs and microservices, wherein the functional atoms are based on isolability, observability, and measurability; and instantiating the service in the network based on the determined placement of the functional atoms.

### FIELD OF THE DISCLOSURE

The present disclosure generally relates to networking systems and methods. More particularly, the present disclosure relates to systems and methods for adaptive and intelligent Network Functions Virtualization (NFV) workload placement.

### BACKGROUND OF THE DISCLOSURE

Network Functions Virtualization (NFV) is a network architecture concept that uses virtualization to transform entire classes of network node functions into building blocks that may connect, or chain together, to create network services. A Virtualized Network Function (VNF) may include one or more Virtual Machines (VMs) running different software and processes, on top of standard high-volume servers, switches, and storage, or even cloud computing infrastructure, instead of having custom hardware appliances for each network function. For example, a virtual session border controller could be deployed to protect a network without the typical cost and complexity of obtaining and installing physical units. Other examples of NFV include virtualized load balancers, firewalls, Domain Name Servers (DNS), intrusion detection devices and Wide Area Network (WAN) accelerators. The NFV framework can be conceptualized with three components generally, namely VNFs, Network Functions Virtualization Infrastructure (NFVI), and Network Functions Virtualization Management and Orchestration Architectural framework (NFV-MANO). Again, VNFs are software implementations of network functions that can be deployed on the NFVI. The NFVI is the totality of all hardware and software components that build the environment where VNFs are deployed. The NFVI can span several locations and the network providing connectivity between these locations is considered as part of the NFVI. The NFV-MANO is the collection of all functional blocks, data repositories used by these blocks, and reference points and interfaces through which these functional blocks exchange information for the purpose of managing and orchestrating NFVI and VNFs.

Conventionally, VNF placement is performed in a single domain, i.e., resources used by a single operator, with manual placement of workloads across facilities, which generally assumes a physical position based on functionality. Disadvantageously, this conventional approach keeps functionality together in assumed blocks rather than optimizing placement. Inside the data center, similar services are designed by operators for placement in common physical space with similar physical NFV/programmable platforms. Virtualization addresses the fluctuations of service demand and ensures that services that are bursting are executed on appropriate equipment often in the same vicinity of similar services and dynamically adapt to failure and maintenance scenarios. These services may be coarse or fine, as is the case with microservices. Where services or microservices are dependent on other services that require a rapid or frequent response, these adjacent services are often physically collocated. Again, these placement decisions are designed by the operators and implemented by virtualization software. Different data centers operated by the same operator are often replicas with variations in size. Each data center services the requests that enter the operator's network in that data center.

In some cases, solutions span multiple data centers including Multi-Tenant Data Centers (MTDCs) and even Service Provider (SP) Colocation where that operator has purchased facilities. In this case, the most time sensitive components of the service are designed for placement near the customer, more backend functionality like analytics, billing, transactional aggregation, content preprocessing, and backup being done in a more core data center. Functions like service assurance and content distribution would often be distributed throughout the network. Again, this is designed by the operator.

In the case of NFV, most services are coarse and are designed by the operator for placement near the consumer of the information or in the network core. Services placed near the consumer generally in place due to security, responsiveness, or to reduce bandwidth (e.g., Deep Packet Inspection (DPI), caching, encryption, authentication, profiling). Service chaining is applied to interconnect these edge services to core services (e.g. VPNs, anti-virus, content control, etc.) which interconnect multiple end points or filter or modify content. Service chaining is used to build more complex network services where multiple VNFs are used in sequence to deliver a network service.

In some advanced scenarios, like Content Distribution Networks (CDNs), the network and the service itself is continuously probed to ensure effective delivery. Should certain service levels fail to be served for a period of time, analytics built on the virtualization system will respond to move services away from anomalous problem resources or infrastructure components and onto backup or newly programmed resources. NFV-MANO systems build service chains with multiple VNF's. These systems instantiate, monitor, repair, and bill for services. An orchestration system can manage VNFs regardless of what VM they run on.

It would be ideal that virtualized functions, services, or microservices are located where they are the most effective and least expensive. That means a service provider should be free to locate NFV in all possible locations, from the data center to the network node to the customer premises. This approach, known as distributed NFV. For some cases, there are clear advantages for a service provider to locate this virtualized functionality at the customer premises. These advantages range from economics to performance to the feasibility of the functions being virtualized.

In the scenarios above, each entity in the service delivery chain (SP, Internet Content Provider (ICP), user, etc.) controls only their own equipment. Decisions made by one entity can have a dramatic effect to all. For example, in moving a service from one ICP data center to another, the service or set of services moved may now enter the service provider network from a completely different location. This causes traffic in an unusual location for the service provider, which may lead to congestion that affects the ICP's services and even services not related to the ICP but using the same infrastructure. This, in turn, causes the ICP's services, perhaps the service providers, and even other ICP's services to fall below expected service levels. In its worst case, this can cause a large number of services to oscillate until operators intervene.

There is a need for systems and methods to communicate such changes and to ensure that all players understand what service placement will do to the service and all players in the value chain for the service. Further, today's largely bookended service placement does not lead to financial or service optimization.

### BRIEF SUMMARY OF THE DISCLOSURE

In an exemplary embodiment, a method for adaptive and intelligent Network Functions Virtualization (NFV) workload placement includes monitoring operation of a network with resources including one or more Virtual Network Functions (VNFs) and microservices; responsive to a request for a service in the network, decomposing the service into interconnected functional atoms, with the functional atoms located in one or more network domains including one or more of different data centers in the network and a user device associated with the service, wherein the functional atoms are decompositions of the VNFs and the microservices into a smaller level of functionality than the VNFs and microservices, wherein the functional atoms are based on isolability, observability, and measurability; and instantiating the service in the network based on the determined placement of the functional atoms. The service can be implemented through a VNF which is formed by a plurality of functional atoms, and wherein at least two of the plurality of functionality atoms are operated on one of different hardware platforms and different physical locations. The service can be implemented through a plurality of functional atoms which communicate to one another through procedure calls of Application Programming Interfaces (APIs). The functional atoms can include any of forwarding functionality, monitoring functionality, timing synchronization functionality, transport and session layer flow functionality, database primitives, session layer messaging primitives, security primitives, and decomposed network routing and control protocols.

The service can be implemented through a plurality of functional atoms, and wherein at least two of the plurality of functionality atoms are in different network domains. The decomposing can include assigning business arrangement inputs, security inputs, and economic inputs to the functional atoms and determining costs for the service in various different arrangements in the network. The service can include a high performance case which is instantiated to measure margins in the network given current conditions in the network. The functional atoms can be located at a combination of an enterprise, a user device, a service provider network, a Content Distribution Network (CDN), an Internet Content Provider (ICP) data center, and a Multi-Tenant Data Center (MTDC). The service can be implemented through a plurality of functional atoms, and wherein at least two of the plurality of functionality atoms communicate to one another. The monitoring operation can include any of measuring volume of data associated with the resources, mapping the volume of data, measuring the latency between the resources, and measuring hardware related costs including of the resources. For the decomposing, the service can be split into different combinations of functional atoms at different locations and assigned associated costs for each of the combinations.

In another exemplary embodiment, a system adapted for adaptive and intelligent Network Functions Virtualization (NFV) workload placement includes a network interface and a processor communicated to one another; and memory storing instructions that, when executed, cause the processor to monitor operation of a network with resources including one or more Virtual Network Functions (VNFs) and microservices, responsive to a request for a service in the network, decompose the service into interconnected functional atoms, with the functional atoms located in one or more network domains including one or more of different data centers in the network and a user device associated with the service, wherein the functional atoms are decompositions of the VNFs and the microservices into a smaller level of functionality than the VNFs and microservices, wherein the functional atoms are based on isolability, observability, and measurability; and cause instantiation of the service in the network based on the determined placement of the functional atoms. The service can be implemented through a VNF which is formed by a plurality of functional atoms, and wherein at least two of the plurality of functionality atoms are operated on one of different hardware platforms and different physical locations.

The service can be implemented through a plurality of functional atoms which communicate to one another through procedure calls of Application Programming Interfaces (APIs). The functional atoms can include any of forwarding functionality, monitoring functionality, timing synchronization functionality, transport and session layer flow functionality, database primitives, session layer messaging primitives, security primitives, and decomposed network routing and control protocols. The service can be implemented through a plurality of functional atoms, and wherein at least two of the plurality of functionality atoms are in different network domains. Decomposition can include assigning business arrangement inputs, security inputs, and economic inputs to the functional atoms and determining costs for the service in various different arrangements in the network. The service can include a high performance case which is instantiated to measure margins in the network given current conditions in the network. The functional atoms can be located at a combination of an enterprise, a user device, a service provider network, a Content Distribution Network (CDN), an Internet Content Provider (ICP) data center, and a Multi-Tenant Data Center (MTDC).

In a further exemplary embodiment, a non-transitory computer readable medium includes instructions that, when executed, cause one or more processors to perform steps of monitoring operation of a network with resources including one or more Virtual Network Functions (VNFs) and microservices; responsive to a request for a service in the network, decomposing the service into interconnected functional atoms, with the functional atoms located in one or more network domains including one or more of different data centers in the network and a user device associated with the service, wherein the functional atoms are decompositions of the VNFs and the microservices into a smaller level of functionality than the VNFs and microservices, wherein the functional atoms are based on isolability, observability, and measurability; and instantiating the service in the network based on the determined placement of the functional atoms.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of an NFV-MANO framework;

FIG. 2 is a block diagram of orchestration in an NFV architecture;

FIG. 3 is a network diagram of an exemplary VNF network architecture;

FIG. 4 is a flowchart of a workload placement process;

FIG. 5 is a flowchart of a process for adaptive and intelligent NFV workload placement;

FIG. 6 is a block diagram of a VNF service chain optimization system; and

FIG. 7 is a block diagram of an exemplary implementation of a server.

### DETAILED DESCRIPTION OF THE DISCLOSURE

Again, in various exemplary embodiments, the present disclosure relates to systems and methods for adaptive and intelligent Network Functions Virtualization (NFV) workload placement. The systems and methods propose adaptive intelligent NFV workload, i.e., VNF, placement. That is, the automated placement and continually re-adjusted placement of NFV workloads in a network between enterprise/residential, the Service Provider (SP), Content Distribution Network Providers (CDNs) and through to the Internet Content Provider (ICP) and Multi-Tenant Data Center (MTDC). Analytics also can be applied to workload placement. Advantageously, the systems and methods include automated static placement and dynamic adjustment of workloads, across multiple network domain, as applied to the telecom space, where spatial network position is not required as an input, and factoring in business arrangement inputs, security inputs, and economic inputs. In an exemplary aspect, the systems and methods include breaking the workload itself into atomic units (functional atoms (FA)) with automated consideration of software architecture and availability of specialized resources (e.g., Field Programmable Gate Arrays (FPGA), Graphics Processing Units (GPU), an amount and type of memory, etc.). Specifically, a key aspect of the systems and methods is decomposition of traditional VNFs, services, or microservices into functional atoms. A closed-loop can be viewed as business/economic/monitoring metric→services→micro-services→interconnected functions→interconnected function atoms→placement of function atoms→monitoring metric. Thus, the systems and methods relate to interconnectivity of these functional atoms rather than the standard VNF concept of “chaining;” functional atom interconnectivity can extend beyond a simple chain, including mesh and the like.

VNF today includes porting an existing stack of software with hardware data functionality to replicate the software for executive exclusively on a Virtual Machine (VM). That is, VNF ports hardware functionality to software. The systems and methods contemplate slicing these existing VNFs, services, or microservices into subcomponents, i.e., the functional atoms. These functional atoms are then composed together, i.e., interconnected, to provide services. The functional atom is in a sense, atomic, in that it is a smaller, sub-function in a larger VNG or service that can be isolated, observed, and measured in a way that has utility. The functional atoms are then interconnected together efficiently for the best deployment.

### NFV-MANO Framework

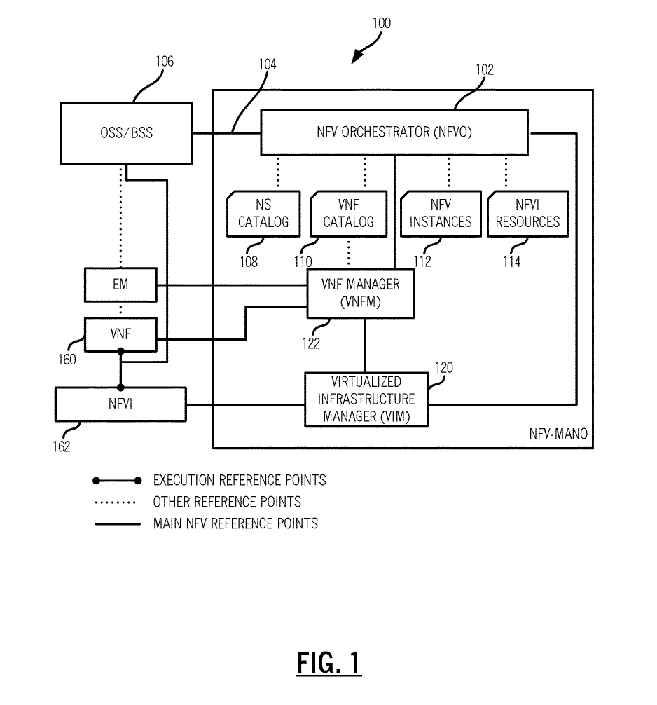

Referring to FIG. 1, in an exemplary embodiment, a block diagram illustrates an NFV-MANO framework 100. Dynamic NFV management aims at utilizing data from orchestration systems 102 for the dynamic management and placement of VNF resources. That is, the dynamic management can be implemented on top of orchestration suites. The dynamic management can be realized in an application that uses the orchestration suites as data sources to perform dynamic management of NFVs. For example, the application can “tap” into a connection 104 between the orchestration systems 102 and an Operations Support System (OSS)/Business Support System (BSS) 106. The connection 104 uses an OS-MA-NFVO protocol. Specifically, the NFV-MANO framework 100 is specified in ETSI GS NFV-MAN 001 “Network Functions Virtualisation (NFV); Management and Orchestration,” V1.1.1 (2014-12), the contents of which are incorporated by reference.

In addition to the orchestration system 102 and the OSS/BSS 106, the NFV-MANO framework 100 includes an NS catalog 108, a VNF catalog 110, NFV instances 112, and NFVI resources 114. The NS catalog 108 contains the repository of all of the on-boarded Network Services. The VNF catalog 110 contains the repository of all of the VNF 160 Packages. The NFV instances 112 contains all of the instantiated VNF and Network Service instances. The NFVI resources 114 contains information about available/reserved/allocated NFVI resources. This repository allows NFVI reserved/allocated resources to be tracked against the NS and VNF instances (e.g. number of Virtual Machines (VMs) used by a certain VNF instance).

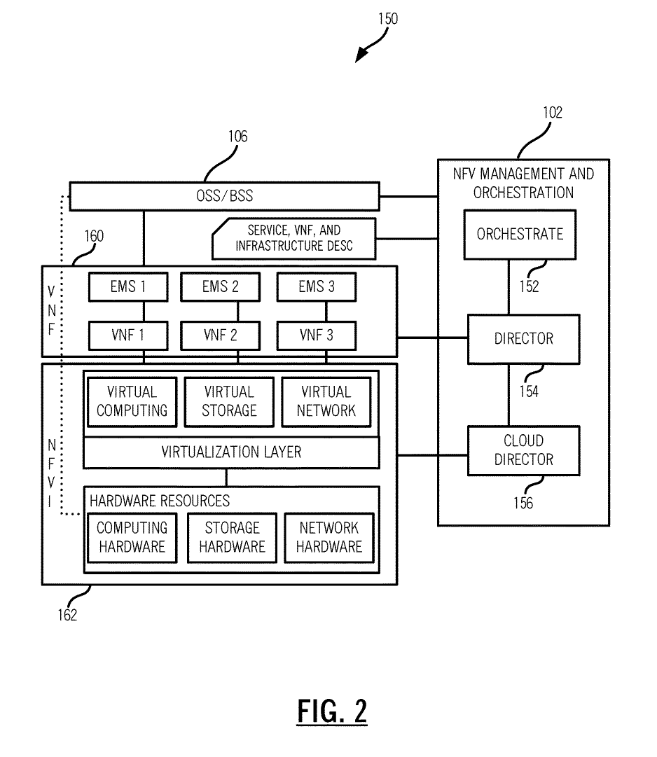

Referring to FIG. 2, in an exemplary embodiment, a block diagram illustrates orchestration 150 in an NFV architecture. The orchestration system 102 includes an orchestrate function 152, a director function 154, and a cloud director function 156. In this exemplary implementation, the orchestrate function 152 is acting the role of the NFV Orchestrator MANO. The cloud director function 156 is a Virtualized Infrastructure Manager (VIM) 120. The director function 154 is a VNF Manger (VNFM) 122.

The dynamic management is a big data analytic product that utilizes the information provided by one or more NFV-MANO systems. The dynamic management analyzes the information in the NFV instances and NFVI 162 resources, to categorize/prioritize the consumed, reserved and available resources. An example is the number of CPU cores, memory, storage and network interfaces available. This kind of information can be within one data center or across many data centers for the service provider.

### VNF Network Architecture

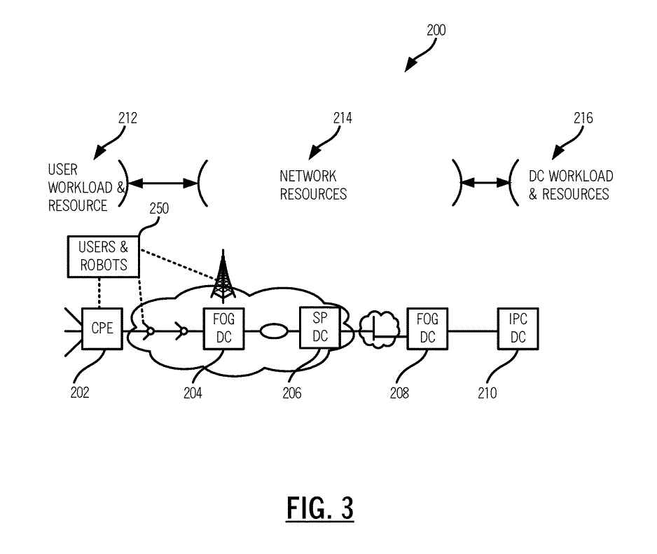

Referring to FIG. 3, in an exemplary embodiment, a network diagram illustrates an exemplary VNF network architecture 200. The VNF network architecture 200 is a typical example of VNF and includes a customer premises equipment (CPE) 202 and various data centers 204, 206, 208, 210. For example, the data center 204 can be an SP-based data center at the network edge, at the head end of a metro network, at a cell tower, or the like. The data center 206 can be an SP-based data center in the SP network. The data center 208 can be a handoff location from the network that connects the ICP to the SP. The data center 210 can be an ICP DC (or an MTDC) with massive compute and storage, including software Wide Area Network (WAN) functionality. Additionally, the VNF network architecture 200 includes resources 212 within device(s) on the user premises, or enterprise/residential owned, or SP owned depending on the business model used (note, there can be several devices owned by different entities). The VNF network architecture 200 can also include SP network resources 214 and DC-based resources 216.

The resources 212, 214, 216 are consumables for the workload set composing a service or set of services, whether through NFV or on bare-metal programmable compute-capable devices. This separation can also be a business separation as there can be at least three entities owning these resources. Often, each of these is also multiple entities that are joined. For example, the SP area might be three SPs in reality, end-to-end. This business separation is important as it influences workload placement and separation, as described herein.

Conventional placement of NFV workloads is usually at two locations offering a bookended service, such as, for example, a WAN optimization (WAN-OP), a Software-Defined WAN (SD-WAN), etc. Workloads can also be placed at single sites, such as, for example, a CPE router at the CPE 202 or the DC 210, a WAN router at any of the DCs 204, 206, 208, etc. Of course, placement could be at any of the locations 202-210. Another complication is that workload placement may be due to business reasons.

Ownership of the resources 212, 214, 216 is typically split between three entities, the resources 212 by an enterprise, the resources 214 by an SP, and the resources 216 by an ICP/MTDC; each of which can be multiple companies stacked up in series or even in parallel. In many cases, the SP also owns some enterprise facilities, e.g., a WAN edge platform. This can affect the decision space for workload placement as it ties together the resources 212, 214.

### Workload Placement and Functional Atoms

Variously, the systems and methods provide workload placement to best deploy and utilize resources along with automated and continuous adjustments to optimally constrain workload distribution to achieve performance targets for business objectives. Again, conventionally, workload placement (assignment) is generally based on classical network topology paradigms, i.e., an edge router goes at the edge, a CPE router goes at the customer premise, etc.

On the contrary, the systems and methods realize that functionality can operate equally at any site and can be extended with a simple transport function (i.e., layer 2 or layer 3 secure Virtual Private Network (VPN)), e.g., the customer premise router function can be relocated within the SP DC by building a L2 VPN to the core SP DC from the CPE.

Microservice architectures (and other equivalences) allow logical partitioning of functionality and their distribution, i.e., NFV are composed of micro services and in fact can be decomposed to molecules or atoms, permitting optimized network resource use to achieve lower cost, higher performance, and a better user experience. Furthermore, different characteristics exist at different sites or by distributing the components of functionality. For example, these characteristics can include power consumption; CPE site uses customer paid electricity; ICP/MTDC are more efficient massive machines and use less electricity but are ICP/MTDC paid; specialization of hardware; CPE sites are generally a simple general purpose computing device, potentially with embedded FPGA resources, and have a specified set of memory; ICP/MTDC/SP DC may have various hardware facilities, e.g., CPU, GPU, FPGA, etc., and large storage facilities of multiple types/cost/performance; increase in bandwidth; each customer is connected with various amounts and quality of bandwidth at various costs; as cheap bandwidth increases, sending packets to other locations for processing becomes easy; etc.

Based on the foregoing, the systems and methods decide where and how each functionality will be placed, in an automated fashion and decomposed to smaller units than today's typical functionality, i.e., based on functional atoms (FAs). As described herein, a functional atom (FA) is a smallest granular level of system functionality that is an observable and measurable practical entity. The FAs have a rational value in potentially being separated, in at least one use-case, from proximate atomic functions without incurring messaging and other overheads obviating the value of separation. The rationale for this separation is increased efficiency and/or functionality.

In conventional NFV, VNFs generally include software executed on hardware to replace the functionality of a physical network device. For example, a VNF router replacing a physical router is conventionally located at the same location as the physical router would have been located. The same holds for any other type of VNFs, i.e., firewalls, web servers, content filtering, security, etc. That is, the traditional approach is to replace a physical network element or appliance with a VNF software component, i.e., a one-to-one correspondence. The present disclosure proposes functional atoms which avoid such as physical deployment correspondence. Specifically, there may be advantages to distribute the VNF software components (now the VNF is composed of functional atoms) at different locations for efficiency, optimization, etc. There does not need to be a one-to-one correspondence between the VNF and the physical device it replaced.

The following are examples including a subset of the potential separation gains: operation on different hardware platforms such as x86 or other Central Processing Units (CPUs), FPGAs, Network Processing Units (NPUs), GPU, etc.; platform resource access (e.g., power, storage, data access, networks, bandwidth, ports, processing power required by FAs) and the resources required by the FAs (e.g., cloud access, Software Defined Network (SDN) network access, co-located multi-petabit storage, etc.); MapReduce/Multi-threading-like functionality that spawns or consolidates parallel processing (e.g., a policy spawning new per flow behaviors); operation in different locations within a site (e.g., functional consolidation within a data center, on device, on server, etc.); operation in different sites (e.g., more centralized or decentralized than adjacent atomic functions); interchangeability (i.e., modules from device operations, third parties, open source, etc. could substitute the atomic level function or an adjacent atomic level function); operation by different providers or networks (e.g., Content Delivery Network and Service Provider); resource cost management (e.g., processing, bandwidth, storage, power in different sites/providers); code testing efficiency; latency management; and the like.

A typical atomic level function is expected to execute for sub-millisecond to single digits of milliseconds before either responding or calling another FA. It is also understood that in common specific FA placements, due to the target environment and use cases, multiple adjacent interacting FAs collocated on common hardware and common software environment will be composed together into a linked sub-service level functional block. This composition would enable direct procedure calls of Application Programming Interfaces (APIs) between the FAs delivering an efficient solution.

Examples of FAs can include, without limitation, forwarding FAs such as base protocol classification, processing of Access Control Lists (ACLs), scheduling, metering, post-parsers, table management, packet modification actions, control flow, queues; Operations, Administration, Maintenance (OAM) such as times, statistics, protection switching, etc.; Timing synchronization services (e.g., IEEE 1588 BC clock) such as time stamper, servo DSP, master protocol, slave protocol, best master selection algorithm, etc.; transport and session layer flows; database primitives such as insert, delete, commit, etc.; session layer messaging primitives such as open, enqueuer, dequeuer, filter, etc.; security primitives such as encryption/decryption, OAUTH framework, etc.; policy reference, application, enforcement; decomposed network routing and control protocols; etc.

As an example, consider a firewall; a hardware implementation includes physical network ports, hardware interconnecting the network ports, and software implementing associated firewall functionality. A conventional firewall VNF takes the software and puts it on a VM machine which replicates the logic of the firmware and connects to virtual ports which emulate the physical network ports. In the systems and methods herein, the conventional firewall VNF can be decomposed into functional atoms such as configuration control and database, filtering, application level, deep packet inspection, etc. Importantly, all of these functional atoms are not required at the same VM. For example, configuration control can be centralized, supporting multiple firewall services.

### Workload Placement Processes

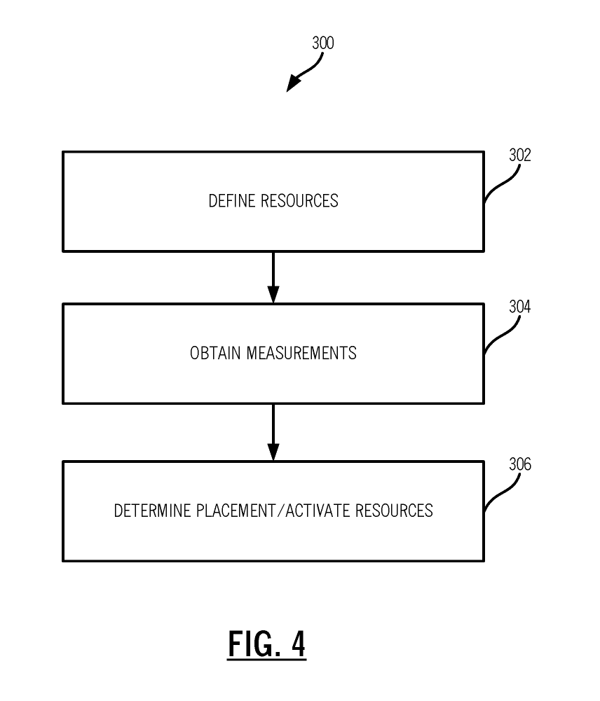

Referring to FIG. 4, in an exemplary embodiment, a flowchart illustrates a workload placement process 300. Decision of functionality placement and operation and amount of resources per function in each location can be based on many parameters. Further, restrictions may occur due to business partitioning, such as, for example, SP cannot place a workload in the ICP, etc. Additionally, the systems and methods can have the ability to negotiate automatically across business boundaries. The workload placement process 300 includes defining resources (step 302), obtaining measurements (step 304), and determining placement/activating the resources (step 306).

The resources are defined as described herein and the resources can be VNFs, FAs, or any other services typically exemplified by microservices. Also, the resources can be defined with business restrictions. Other restrictions may include keep out zones. For example, a customer may wish to ensure an encrypted tunnel for part of the data remains encrypted across the SP core and only opened at the ICP/MTDC be it for regulatory or other reasons. This precludes using SP resources in this example, even if cheaper.

To obtain measurements, known parameters are modeled, such as, for example available compute, type of compute (e.g., x86, GPU, NPU, FPGA, etc.), available storage, location of compute/storage, available power, environmental conditions (i.e., temperature, etc.), theoretical workload and requirements of service and associated microservices, contractual requirements, security requirements, geopolitical constraints (e.g., EU data must remain in the EU), etc.

The process 300 includes measurements on the operation, i.e., the process 300 specifically includes measurement of actual workload performance and feedback therefrom for analysis and potential reassignment to new resources. Examples of measurements on operation can include, without limitation, volume of data between microservices; volume of data to the service (e.g., for NFV this would be the raw packet feed); map of volume of data (e.g., for an NFV router with n ports there are packet flows that return to the source and some that continue to other destinations); latency of data transmission between resources; actual memory footprint and storage requirements; actual power consumption; actual security use; actual costs, traffic over connectivity (e.g., if metered per volume), cost of compute resources at current location; actual network and resource topology; etc.

The process 300 can include modeling to determine placement. The modeling can include determining a cost of moving functionality to different areas given different resources and cost profiles, and the functionality can be services, VNFs, microservices, etc. As part of this modeling, the process 300 can include the ability to split current functionality/workloads knowing characteristics of data flow between microservices, including considering future emergence with re-factoring of currently monolithic functionalities over time enabling finer redistributive opportunities. The modeling projected functionality can include memory, compute, throughput, latency, etc.

The modeling and determining placement can be a multivariable optimization. When pushed to its limit, this can lead to a sea of microservices or atomic level functionality, detached from actual functionality. For example, a router VNF could easily be broken into a set of microservices and not be kept together as “a router” and it might be mixed with other functionality. As long as throughput and compute capabilities are maintained, this is fine and in fact, it is more efficient for automation and use of the network. Thus, the process 300 can provide significant resource and cost efficiencies. In an exemplary embodiment, pre-negotiated dynamic multi-domain service agreements between domains and service providers can be modeled against available functional placement within different network domains including understanding the latitude in placement, functions, micro-services, compute, and storage when making a dynamic service request.

The activation includes a manual or automated workload or resource placement based on the determination and the measurements, including based on analysis, big data analytics. Responsive to receiving a request to create a new function/workload with specific or variable service parameters, the process 300 includes calls upon the model of that functionality and factors the parameters into that model. The optional pre-negotiated dynamic multi-domain service model and the model of the function/workload to micro-service are applied to the above-mentioned new function/workload model to provide a model of the potential micro-services or FA placement and the related resources (memory, compute, throughput, latency). This new model has factored into it the function/workload constraints created by the new function/workload request, the domain agreements, the micro-service needs, geopolitical constraints, the function/workload security model and their fit into the service/workload micro-service model and its constraints.

Algorithms are then utilized to model the optimal placement of the micro-services/FA in each domain, server, and the resources (including all components network, compute, storage) based on a cost factor (or some other weighting). This cost factor is a variable that may factor CapEx cost, operational cost, power usage and cost, space usage and cost, and/or any other measured or configured metric. The optimal model is then applied to a Hypervisor/Network Function Orchestrator in each domain through a pre-negotiated interface, if applicable, to create the service instantiation. There are some VNF functions that are constrained in their movement, for example, some types of encryption functions. The process 300 shall allow for such constraints. The analysis can be any known technique from simple multi-variable solution sets to adaptive or Artificial Intelligence (AI) driven solution sets.

In an exemplary embodiment, a solution from the process 300 is applied to the instantiated but not activated workload/function to confirm performance behavior is appropriate, and the workload/function is then activated. Before rolling out a new network, service, or function, an operator may create a test network to verify functionality and/or scale. Measurements from this intermediate network (e.g., reliability, scale, etc.) can feed into the activation decision. The test network can also be a continually adjusted system. For example, a small test function could be bombarded with a higher percentage of difficult scenarios in order to provide an idea of how much margin exists. The test function could continuously rotate through the real function to achieve broad coverage. It can apply to a test network or as a small % of the real data network (e.g., 5% of data is run through it). Thus, one major claim thread is the test before deployed. Optionally, for active autoNFV/workloads could be performance monitored through Transmission Control Protocol (TCP) or application layer functions that measure true function/workload performance. Optionally, the performance monitoring of various different instances of each function/workload is recorded in a database. Analytics are applied to this database to determine absent or excessive constraints, adjust microservice to resource requirement estimates, and adapt the cost optimization model to reflect reality better.

It is also possible that endpoints are closer to the user such as ‘residential’ and ‘enterprise’. However, the microservices or FAs can get closer including right to the user device (i.e., phone, smartwatch, laptop, tablet, robots such as security camera or other automated devices, etc.). As such, attributes such as Global Positioning Satellite (GPS) location, battery power, privacy, network connection, etc. can be taken into account. Dynamic connections between these elements when they are located near each other can also be formed (e.g. Wi-Fi direct) for the purpose of improving VNF functionality. These robots 250 are shown in FIG. 3.

Further, the process 300 can include moving microservices or FAs, such as between an x86, GPU, Network Interface Card (NIC), and FPGA acceleration engine all residing within a same compute module, for optimization.

### Dynamic Behavior

The process 300 can be implemented when there is a request to create a new function/workload. Also, the process 300 can be dynamic. The process 300 can include deploying actual service flows and measuring actual performance and parameters before deploying live; pushing extreme performance cases (example heavy workloads) to measure margins in network resources given current workload distribution; trying different combinations of workload combinations to how the network operates; placing some % of customers on new services before putting all, and observing service delivery, potentially changing the services slightly to approximate what is asked for and seeing if customers are satisfied by measuring their use of that service, or service calls; etc.

### Process for Adaptive and Intelligent NFV Workload Placement

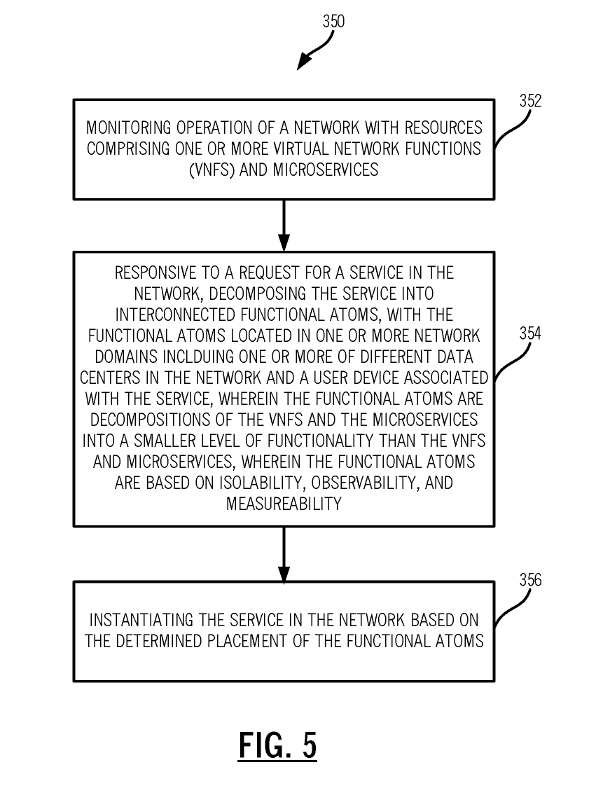

Referring to FIG. 5, in an exemplary embodiment, a flowchart illustrates a process 350 for adaptive and intelligent NFV workload placement. The process 350 includes monitoring operation of a network with resources comprising one or more Virtual Network Functions (VNFs) and microservices (step 352); responsive to a request for a service in the network, decomposing the service into interconnected functional atoms, with the functional atoms located in one or more network domains including one or more of different data centers in the network and a user device associated with the service, wherein the functional atoms are decompositions of the VNFs and the microservices into a smaller level of functionality than the VNFs and microservices, wherein the functional atoms are based on isolability, observability, and measurability (step 354); and instantiating the function in the network based on the determined placement of the functional atoms (step 356).

The service can be implemented through a VNF, which is formed by a plurality of functional atoms, and wherein at least two of the plurality of functionality atoms are operated on one of different hardware platforms and different physical locations. The service can be implemented through a plurality of functional atoms which communicate to one another through procedure calls of Application Programming Interfaces (APIs). The functional atoms can include any of forwarding functionality, monitoring functionality, timing functionality, transport and session layer flow functionality, database primitives, session layer messaging primitives, security primitives, and decomposed network routing and control protocols. The service can be implemented through a plurality of functional atoms, and wherein at least two of the plurality of functionality atoms are in different network domains.

The decomposing can include assigning business arrangement inputs, security inputs, and economic inputs to the functional atoms and determining costs for the function in various different arrangements in the network. The service can include a high-performance case which is instantiated to measure margins in the network given current conditions in the network. The functional atoms can be located at a combination of an enterprise, a user device, a service provider network, an Internet Content Provider (ICP) data center, and a Multi-Tenant Data Center (MTDC). The service can be implemented through a plurality of functional atoms, and wherein at least two of the plurality of functionality atoms communicate to one another via a Layer 2 Virtual Private Network (VPN). The monitoring operation can include any of measuring the volume of data associated with the resources, mapping the volume of data, measuring the latency between the resources, and measuring hardware related costs comprising of the resources. For the decomposing, the service can be split into different combinations of functional atoms at different locations and assigned associated costs for each of the combinations.

### VNF Service Chain Optimization System

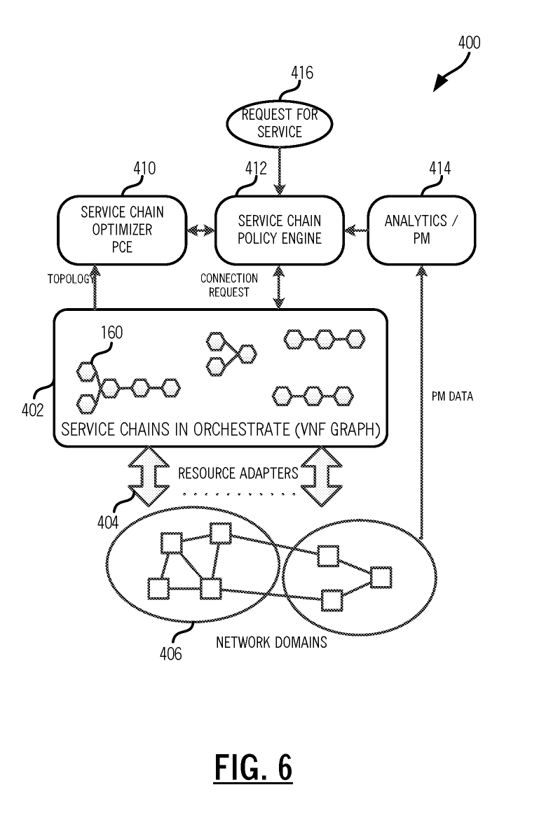

Referring to FIG. 6, in an exemplary embodiment, a block diagram illustrates a VNF service chain optimization system 400. The VNF service chain optimization system 400 includes an SDN orchestrator 402, VNF resources 160, resource adapters 404 to perform orchestration with different elements in a network 406, a Service Chain Optimizer PCE 410, a Policy Engine 412, and a database 414 for analytics and performance monitoring data. In order to orchestrate the VNFs, the service chain optimization system 400 supports implementing the process 350 for adaptive and intelligent NFV workload placement using functional atoms to compose the VNF resources 160.

Operationally, a request for service 416 is received, i.e., a request for a new function in the network 406 which is provided by VNF resources 160. The request for service 416 can be received through the policy engine 412. The policy engine 412 is communicatively coupled to the database 414 for analytics and performance monitoring data from the network 406. The policy engine 412 handles the request for service 416 through the PCE 410 which can implement the process 350 to optimize the service chain, i.e., the VNF graph.

### Exemplary Server

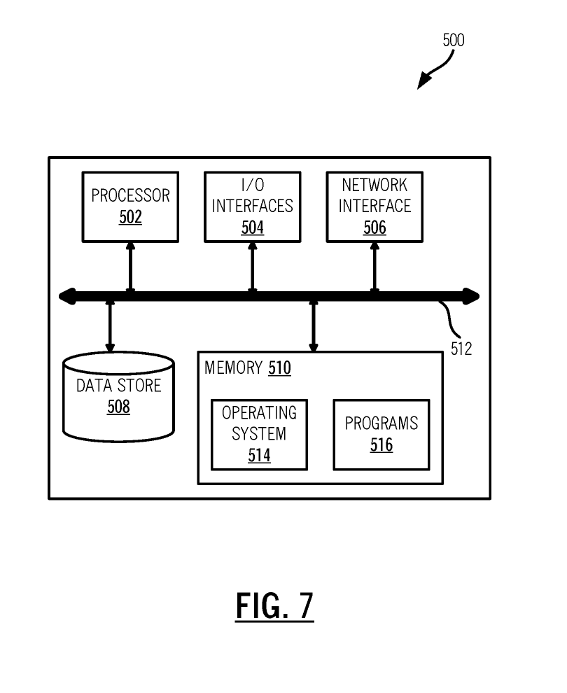

Referring to FIG. 7, in an exemplary embodiment, a block diagram illustrates an exemplary implementation of a server 500. The server 500 can be a digital processing device that, in terms of hardware architecture and functionality, generally includes a processor 502, input/output (I/O) interfaces 504, a network interface 506, a data store 508, and memory 510. It should be appreciated by those of ordinary skill in the art that FIG. 7 depicts the server 500 in an oversimplified manner, and a practical embodiment may include additional components and suitably configured processing logic to support known or conventional operating features that are not described in detail herein. The components (502, 504, 506, 508, and 510) are communicatively coupled via a local interface 512. The local interface 512 can be, for example, but not limited to, one or more buses or other wired or wireless connections, as is known in the art. The local interface 512 can have additional elements, which are omitted for simplicity, such as controllers, buffers (caches), drivers, repeaters, and receivers, among many others, to enable communications. Further, the local interface 512 can include address, control, and/or data connections to enable appropriate communications among the aforementioned components.

The processor 502 is a hardware device for executing software instructions. The processor 502 can be any custom made or commercially available processor, a central processing unit (CPU), an auxiliary processor among several processors associated with the server 500, a semiconductor-based microprocessor (in the form of a microchip or chip set), or generally any device for executing software instructions. When the server 500 is in operation, the processor 502 is configured to execute software stored within the memory 510, to communicate data to and from the memory 510, and to generally control operations of the server 500 pursuant to the software instructions. The I/O interfaces 504 can be used to receive user input from and/or for providing system output to one or more devices or components. The network interface 506 can be used to enable the server 500 to communicate on a network.

The data store 508 can be used to store data. The data store 508 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 508 can incorporate electronic, magnetic, optical, and/or other types of storage media. The memory 510 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 can incorporate electronic, magnetic, optical, and/or other types of storage media. Note that the memory 510 can have a distributed architecture, where various components are situated remotely from one another, but can be accessed by the processor 502. The software in memory 510 can include one or more software programs, each of which includes an ordered listing of executable instructions for implementing logical functions. The software in the memory 510 includes a suitable operating system (O/S) 514 and one or more programs 516. The operating system 514 essentially controls the execution of other computer programs, such as the one or more programs 516, and provides scheduling, input-output control, file and data management, memory management, and communication control and related services. The one or more programs 516 may be configured to implement the various processes, algorithms, methods, techniques, etc. described herein.

In another exemplary embodiment, a system adapted for adaptive and intelligent Network Functions Virtualization (NFV) workload placement includes a network interface and a processor communicated to one another; and memory storing instructions that, when executed, cause the processor to monitor operation of a network with resources comprising one or more Virtual Network Functions (VNFs) and microservices, responsive to a request for a function in the network, model the function with the resources to determine placement of functional atoms for the function across one or more domains of the network, between different data centers in the network, and up to a user device associated with the function, wherein the functional atoms are decompositions of the VNFs and the microservices into a smaller level of functionality than the VNFs and microservices that are observable and measurable; and cause instantiation of the function in the network based on the determined placement of the functional atoms.

In a further exemplary embodiment, a non-transitory computer readable medium includes instructions that, when executed, cause one or more processors to perform steps of: monitoring operation of a network with resources comprising one or more Virtual Network Functions (VNFs) and microservices; responsive to a request for a function in the network, modeling the function with the resources to determine placement of functional atoms for the function across one or more domains of the network, between different data centers in the network, and up to a user device associated with the function, wherein the functional atoms are decompositions of the VNFs and the microservices into a smaller level of functionality than the VNFs and microservices that are observable and measurable; and instantiating the function in the network based on the determined placement of the functional atoms.

It will be appreciated that some exemplary embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various exemplary embodiments.

Moreover, some exemplary embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method for adaptive and intelligent Network Functions Virtualization (NFV) workload placement, the method comprising:
monitoring operation of a network with resources comprising one or more Virtual Network Functions (VNFs) and microservices;
responsive to a request for a service in the network, decomposing the service into interconnected functional atoms, with the functional atoms located in one or more network domains comprising one or more of different data centers in the network and a user device associated with the service, wherein the functional atoms are decompositions of the VNFs and the microservices into a smaller level of functionality than the VNFs and microservices, wherein the functional atoms are based on isolability, observability, and measurability; and
instantiating the service in the network based on the determined placement of the functional atoms.

2. The method of claim 1, wherein the service is implemented through a VNF which is formed by a plurality of functional atoms, and wherein at least two of the plurality of functionality atoms are operated on one of different hardware platforms and different physical locations.

3. The method of claim 1, wherein the service is implemented through a plurality of functional atoms which communicate to one another through procedure calls of Application Programming Interfaces (APIs).

4. The method of claim 1, wherein the functional atoms comprise any of forwarding functionality, monitoring functionality, timing synchronization functionality, transport and session layer flow functionality, database primitives, session layer messaging primitives, security primitives, and decomposed network routing and control protocols.

5. The method of claim 1, wherein the service is implemented through a plurality of functional atoms, and wherein at least two of the plurality of functionality atoms are in different network domains.

6. The method of claim 1, wherein the decomposing comprises assigning business arrangement inputs, security inputs, and economic inputs to the functional atoms and determining costs for the service in various different arrangements in the network.

7. The method of claim 1, wherein the service comprises a high performance case which is instantiated to measure margins in the network given current conditions in the network.

8. The method of claim 1, wherein the functional atoms are located at a combination of an enterprise, a user device, a service provider network, a Content Distribution Network (CDN), an Internet Content Provider (ICP) data center, and a Multi-Tenant Data Center (MTDC).

9. The method of claim 1, wherein the service is implemented through a plurality of functional atoms, and wherein at least two of the plurality of functionality atoms communicate to one another.

10. The method of claim 1, wherein the monitoring operation comprises any of measuring volume of data associated with the resources, mapping the volume of data, measuring the latency between the resources, and measuring hardware related costs comprising of the resources.

11. The method of claim 1, wherein, for the decomposing, the service is split into different combinations of functional atoms at different locations and assigned associated costs for each of the combinations.

12. A system adapted for adaptive and intelligent Network Functions Virtualization (NFV) workload placement, the system comprising:
a network interface and a processor communicated to one another; and
memory storing instructions that, when executed, cause the processor to
monitor operation of a network with resources comprising one or more Virtual Network Functions (VNFs) and microservices,
responsive to a request for a service in the network, decompose the service into interconnected functional atoms, with the functional atoms located in one or more network domains comprising one or more of different data centers in the network and a user device associated with the service, wherein the functional atoms are decompositions of the VNFs and the microservices into a smaller level of functionality than the VNFs and microservices, wherein the functional atoms are based on isolability, observability, and measurability; and
cause instantiation of the service in the network based on the determined placement of the functional atoms.

13. The system of claim 12, wherein the service is implemented through a VNF which is formed by a plurality of functional atoms, and wherein at least two of the plurality of functionality atoms are operated on one of different hardware platforms and different physical locations.

14. The system of claim 12, wherein the service is implemented through a plurality of functional atoms which communicate to one another through procedure calls of Application Programming Interfaces (APIs).

15. The system of claim 12, wherein the functional atoms comprise any of forwarding functionality, monitoring functionality, timing synchronization functionality, transport and session layer flow functionality, database primitives, session layer messaging primitives, security primitives, and decomposed network routing and control protocols.

16. The system of claim 12, wherein the service is implemented through a plurality of functional atoms, and wherein at least two of the plurality of functionality atoms are in different network domains.

17. The system of claim 12, wherein decomposition comprises assigning business arrangement inputs, security inputs, and economic inputs to the functional atoms and determining costs for the service in various different arrangements in the network.

18. The system of claim 12, wherein the service comprises a high performance case which is instantiated to measure margins in the network given current conditions in the network.

19. The system of claim 12, wherein the functional atoms are located at a combination of an enterprise, a user device, a service provider network, a Content Distribution Network (CDN), an Internet Content Provider (ICP) data center, and a Multi-Tenant Data Center (MTDC).

20. A non-transitory computer readable medium comprising instructions that, when executed, cause one or more processors to perform steps of:
monitoring operation of a network with resources comprising one or more Virtual Network Functions (VNFs) and microservices;
responsive to a request for a service in the network, decomposing the service into interconnected functional atoms, with the functional atoms located in one or more network domains comprising one or more of different data centers in the network and a user device associated with the service, wherein the functional atoms are decompositions of the VNFs and the microservices into a smaller level of functionality than the VNFs and microservices, wherein the functional atoms are based on isolability, observability, and measurability; and
instantiating the service in the network based on the determined placement of the functional atoms.
